(19) United States
(12) Patent Application Publication
(10) Pub. No.: US 2018/0348904 A1
(43) Pub. Date: Dec. 6, 2018

(54) DISPLAY APPARATUS WITH POSITION INPUT FUNCTION

(71) Applicant: SHARP KABUSHIKI KAISHA, Sakai City, Osaka (JP)

(72) Inventor: MIKIHIRO NOMA, Sakai City (JP)

(73) Assignees: SHARP KABUSHIKI KAISHA, Sakai City, Osaka (JP); SHARP KABUSHIKI KAISHA, Sakai City, Osaka (JP)

(21) Appl. No.: 15/757,929

(22) PCT Filed: Sep. 2, 2016
(86) PCT No.: PCT/JP2016/075764

§ 371 Date: Mar. 6, 2018

(30) Foreign Application Priority Data
Sep. 9, 2015 (JP) 2015-177342

(51) Int. Cl. G06F 3/044; G06F 3/041; G02F 1/1333

(52) U.S. Cl. CPC G06F 3/044; G06F 3/0416; G06F 2203/04102; G02F 1/13338; G06F 3/0412

(57) ABSTRACT

A liquid crystal display device includes a liquid crystal panel, a housing, a position detection electrode, and a calculation unit. The housing accommodates the liquid crystal panel. The housing is made of conductive made of conductive material and disposed to cover at least a surface of the liquid crystal panel on an opposite side from a display surface of the display panel. The position detection electrode is disposed on the liquid crystal panel such that the position detection electrode and the housing have electrostatic capacitance therebetween and the position detection electrode and a finger have electrostatic capacitance therebetween to detect an input position. The calculation unit is configured to calculate a pressure in a normal direction to the display surface based on a difference in signal regarding the electrostatic capacitance detected when a position change regarding the input position detected by the position detection electrode is within a specified range.

### TECHNICAL FIELD

The present invention relates to a display device with position input function.

### BACKGROUND ART

In recent years, development of a touch display device equipped with a touch panel has been promoted for the purpose of improvement of operability and usability of electronic devices such as tablet laptops and smartphones. A touch display device described in Patent Document 1 identified below is known as an example of a touch display device. The touch display device described in Patent Document 1 includes a display touch screen including a first substrate, a second substrate, a liquid crystal layer, and a plurality of pixel units. The display touch screen includes a plurality of common electrodes arranged in a two-dimensional array. A display touch control circuit includes a display control circuit and a touch control circuit. For implementation of display, the display touch control circuit is connected to the plurality of common electrodes via wires to connect the plurality of common electrodes to a common level provided for the display control circuit. For implementation of touch detection, each of the plurality of common electrodes functioning as a touch detection electrode is connected to the touch control circuit.

### CITATION LIST

### Patent Document

Patent Document 1: Japanese Patent Application Laid-Open No. 2014-238816

### Problem to be Solved by the Invention

According to Patent Document 1 described above, a touch position is detected in a plane of the display touch screen. However, an action performed by a user to depress the display touch screen is not detectable.

### DISCLOSURE OF THE PRESENT INVENTION

The present invention has been completed in consideration of the aforementioned circumstances. An object of the present invention is to detect an action for depressing a display surface.

### Means for Solving the Problem

A display device with position input function according to the present invention includes a display panel, a housing, a position detection electrode, and a calculation unit. The housing accommodates the display panel. The housing is made of conductive material and disposed to cover at least a surface of the display panel on an opposite side from a display surface of the display panel. The position detection electrode is disposed on the display panel such that the position detection electrode and the housing have electrostatic capacitance therebetween and the position detection electrode and a position input body that inputs a position in a plane of the display surface have electrostatic capacitance therebetween to detect an input position of the position input body. The calculation unit is configured to calculate a pressure in a normal direction to the display surface based on a difference of a signal associated with the electrostatic capacitance detected when a position change regarding the input position of the position input body detected by the position detection electrode is within a specified range.

According to this configuration, an input position of the position input body is detected by the position detection electrode when a position is input to the plane of the display surface of the display panel by the position input body. The position detection electrode and the housing made of conductive material have the electrostatic capacitance therebetween. The position detection electrode and the position input body have the electrostatic capacitance therebetween. There is a possibility of the presence of an action for depressing the display panel in the normal direction to the display surface (pressing action) by the position input body when a position change regarding the input position of the position input body detected by the position detection electrode is within the specified range. When the position input body performs the pressing action herein, the display panel comes into a flexing state. In addition, the position detection electrode disposed on the display panel shifts to approach the housing disposed to cover the surface of the display panel on the opposite side from the display surface. As a result, electrostatic capacitance between the position detection electrode and the housing increases. In this case, the calculation unit calculates a difference in signal regarding electrostatic capacitance detected when a position change regarding the input position of the position input body detected by the position detection electrode is within the specified range. The calculated difference corresponds to a change in the signal regarding the electrostatic capacitance resulting from the pressing action of the position input body. The pressure in the normal direction to the display surface of the display panel is calculated based on this difference. Accordingly, the pressure associated with a pressing action is acquirable as well as an input position on the display surface of the display panel without the necessity of a sensor for pressure detection or the like.

Following configurations are preferable as embodiments of the present invention.

(1) The calculation unit calculates the pressure by multiplying the difference by a correction coefficient corresponding to an input position on the display surface. A displacement magnitude of the position detection electrode caused by flexing of the display panel as a result of a pressing action by the position input body varies in accordance with an input position on the display surface. The displacement magnitude tends to become relatively larger in a central region of the display surface, and become relatively smaller in an end region of the display surface. Accordingly, the calculation unit is configured to multiply a difference associated with electrostatic capacitance by a correction coefficient corresponding to an input position on the display surface at the time of calculation of the pressure. This correction coefficient is derived based on an input position on the display surface. The correction coefficient tends to be a relatively small value when the input position lies in the central region of the display surface, for example, but a relatively large value when the input position lies in the end region of the display surface. By adoption of the correction coefficient determined as above, the pressure calculated by the calculation unit becomes more appropriate for any input position.

(2) There is provided a memory that stores, as a reference value, a signal associated with electrostatic capacitance acquired when a variation associated with an input position and detected by the position detection electrode exceeds a threshold. The calculation unit calculates the pressure based on a difference between a signal associated with electrostatic capacitance acquired when the variation does not exceed the threshold, and the reference value stored in the memory. When the variation associated with the input position and detected by the position detection electrode exceeds the threshold, the input position of the position input body is in a shifting state. In this case, the memory stores a signal associated with acquired electrostatic capacitance as a reference value. On the other hand, when the variation associated with the input position detected by the position detection electrode does not exceed the threshold, there is a possibility that the pressing action is performed in a stop state of the input position of the position input body. In this case, the calculation unit calculates the pressure based on a difference between a signal associated with acquired electrostatic capacitance and the reference value stored in the memory. As described above, a reference value of a signal associated with electrostatic capacitance is acquired based on a variation associated with an input position detected by the position detection electrode before calculating the pressure. Because the pressure is can be calculated based on the appropriate reference value, the more appropriate pressure can be achieved.

(3) The memory stores, as the reference value, a peak value in the signal associated with the electrostatic capacitance acquired when the variation exceeds the threshold. According to this configuration, the volume of information stored in the memory becomes smaller in comparison with a configuration which stores a whole signal associated with electrostatic capacitance. Accordingly, reduction of the memory size is achievable.

(4) The housing includes a bottom portion that covers the surface of the display panel opposite to the display surface. The bottom portion has a shape curved such that the distance between the bottom portion and the display panel gradually decreases from a central region of the display surface toward an end region of the display surface. When the pressure is constant, a displacement magnitude of the position detection electrode caused by a pressing action by the position input body tends to become relatively smaller in the end region of the display surface of the display panel than in the central region. On the other hand, when the bottom portion has a curved shape as described above, electrostatic capacitance produced between the bottom portion and the position detection electrode becomes relatively larger in the end region of the display surface of the display panel than in the central region. Accordingly, detection sensitivity for the pressure in the end region of the display surface improves, wherefore a difference between detection sensitivity in the end region and detection sensitivity in the central region decreases.

(5) A driver configured to drive the position detection electrode is mounted on the display panel. The calculation unit is included in the driver. According to this configuration, the pressure is calculated by the calculation unit included in the driver mounted on the display panel. Accordingly, this configuration is preferable in view of increasing a pressure calculation speed.

(6) There are provided a connection part one end of which is connected to the display panel, and a control circuit board connected to the other end of the connection part. The calculation unit is included in the control circuit board. According to this configuration, the calculation unit included in the control circuit board is configured to calculate the pressure based on a signal transmitted from the display panel via the connection part. Accordingly, size reduction of the driver is achievable in comparison with a configuration which incorporates the calculation unit in a driver mounted on a display panel or a connection part.

(7) The calculation unit does not calculate the pressure when the difference does not exceed a threshold, but calculates the pressure when the difference exceeds the threshold. According to this configuration, the calculation unit does not calculate pressure when the difference associated with the electrostatic capacitance detected by the position detection electrode does not exceed the threshold. Accordingly, the absence of the pressing action is detectable. On the other hand, when the difference between the maximum value of electrostatic capacitance detected by the position detection electrode and the reference value exceeds the threshold, the calculation unit calculates the pressure. Accordingly, the presence of the pressing action is detectable based on the execution of the calculation. In this manner, the presence or absence of the pressing action is detectable.

(8) The position detection electrode is formed within the display panel. This configuration is preferable in view of thickness reduction in comparison with a configuration which forms the position detection electrode in a touch panel as a component separated from the display panel.

(9) The display panel includes at least a pixel electrode to which voltage is applied with gradation corresponding to an image displayed on the display surface, and a common electrode to which common potential is applied. The common electrode includes a plurality of divisional common electrodes disposed in a matrix in the plane of the display surface, and constituting the position detection electrode. According to this configuration, a predetermined image is displayed on the display surface of the display panel based on a potential difference between the pixel electrode and the common electrode. The common electrode is divided into the plurality of divisional common electrodes which constitute the position detection electrode. Accordingly, this configuration is preferable in view of simplification of the structure, cost reduction and the like in comparison with a configuration which provides the position detection electrode separately from the common electrode.

(10) The display panel includes at least a plurality of wires each of which is connected to the corresponding one of the plurality of divisional common electrodes. According to this configuration, identical common potential is applied to the plurality of divisional common electrodes via the plurality of wires for display of an image on the display surface. On the other hand, for position detection and pressure detection, discrete position detection signals are supplied to the plurality of divisional common electrodes via the plurality of wires to specify an input position of the position input body. Accordingly, this configuration is preferable in view of increasing position detection sensitivity and pressure detection sensitivity, and also in view of detection of multi-touch at two or more input positions.

(11) The display panel includes at least a pair of substrates overlapped with the display panel on the housing side and on the opposite side, respectively. The position detection electrode is provided on the substrate disposed on the housing side in the pair of substrates. According to this configuration, the distance between the position detection electrode and the housing decreases in comparison with a configuration which provides the position detection electrode on the substrate opposite to the housing side. Accordingly, position detection sensitivity and pressure sensitivity further improve.

### Advantageous Effect of the Invention

According to the present invention, an action for depressing a display surface is detectable.

### BRIEF DESCRIPTION OF THE DRAWINGS

FIG. 1 is a plan view of a liquid crystal display device according to a first embodiment of the present invention;

FIG. 2 is a is a schematic cross-sectional view of the liquid crystal display device taken in a short side direction;

FIG. 3 is a schematic cross-sectional view illustrating a cross-sectional configuration of a display area of a liquid crystal panel;

FIG. 4 is a plan view schematically illustrating a wiring configuration of a display area of an array substrate constituting the liquid crystal panel;

FIG. 5 is an enlarged plan view illustrating a planar configuration of a display area of a CF substrate constituting the liquid crystal panel;

FIG. 6 is a cross-sectional view of the array substrate taken along a line A-A in FIG. 3;

FIG. 7 is a plan view illustrating a planar position of a common electrode on the array substrate constituting the liquid crystal panel;

FIG. 8 is a block diagram illustrating a relationship between components associated with position detection and pressure calculation;

FIG. 9 is a flowchart for calculating a pressure associated with a pressing action by a finger;

FIG. 10 is a schematic cross-sectional view illustrating a pressed state of a central region of a display surface of the liquid crystal panel;

FIG. 11 is a schematic cross-sectional view illustrating a pressed state of an end region of the display surface of the liquid crystal panel;

FIG. 12 is a graph illustrating a reference value of an input position of a finger, and a reference value of a signal of electrostatic capacitance in a state prior to a pressing action;

FIG. 13 is a graph illustrating an input position of the finger and a signal of electrostatic capacitance in a state subjected to a pressing action;

FIG. 14 is a graph illustrating a state after subtraction of the reference value of the signal of electrostatic capacitance from the signal of the detected electrostatic capacitance;

FIG. 15 is a flowchart for calculating a pressure associated with a pressing action by the finger according to a second embodiment of the present invention;

FIG. 16 is a schematic cross-sectional view of a liquid crystal display device taken in a short side direction according to a third embodiment of the present invention;

FIG. 17 is a schematic cross-sectional view illustrating a pressed state of a central region of a display surface of a liquid crystal panel;

FIG. 18 is a flowchart for calculating a pressure associated with a pressing action by the finger according to a fourth embodiment of the present invention; and

FIG. 19 is a flowchart for calculating a pressure associated with a pressing action by the finger according to a fifth embodiment of the present invention.

### BEST MODE FOR CARRYING OUT THE INVENTION

### First Embodiment

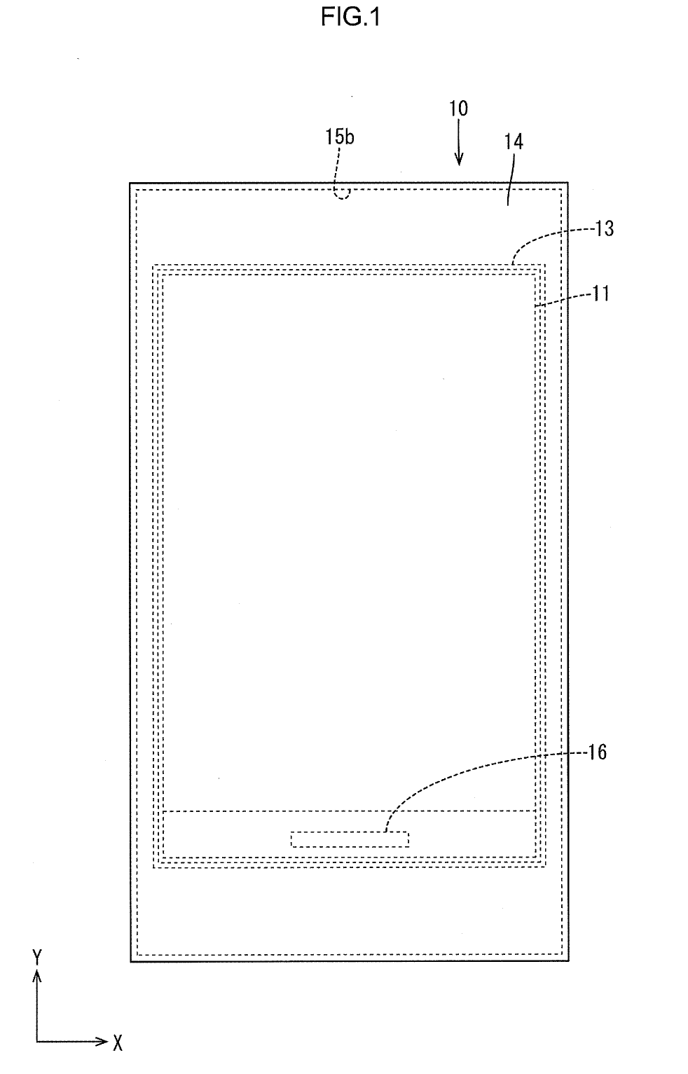

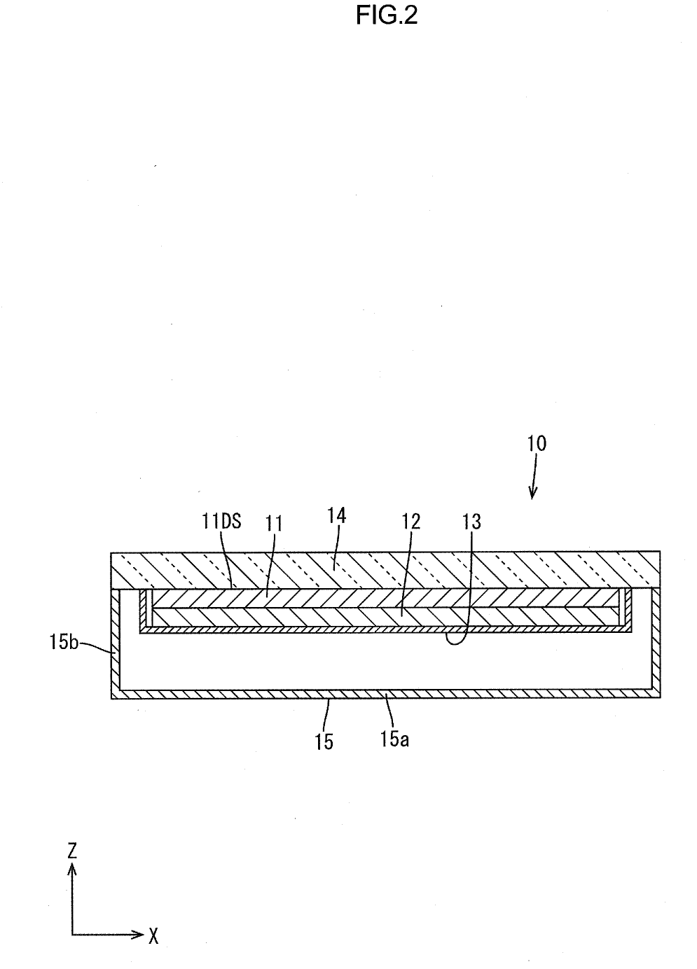

A first embodiment of the present invention is described with reference to FIGS. 1 to 14. Presented according to the present embodiment by way of example is a liquid crystal display device (display device with position input function) 10 having a position input function. A part of the respective figures indicate X axis, Y axis, and Z axis for depiction such that the respective axes coincide with the respective directions shown in the corresponding figures. It is also assumed that an upper side in each of FIGS. 2, 3, 6 and other figures corresponds to a front side, and that a lower side in each of these figures corresponds to a rear side.

The overall shape of the liquid crystal display device 10 is a rectangular shape. As illustrated in FIGS. 1 and 2, the liquid crystal display device 10 at least includes a liquid crystal panel (display panel) 11 equipped with a display surface 11DS on a front plate surface of the liquid crystal panel 11 to display an image on the display surface 11DS, a backlight device (illumination device) 12 disposed on the rear side of the liquid crystal panel 11 (opposite to display surface 11DS) and corresponding to an external light source which applies light for display to the liquid crystal panel 11, a case 13 which accommodates the liquid crystal panel 11 and the backlight device 12, a cover glass (protection panel) 14 disposed on the front side of the liquid crystal panel 11, and a housing 15 disposed on the rear side of the case 13 and the cover glass 14 to cover the case 13 and the cover glass 14 from the rear. The liquid crystal display device 10 according to the present embodiment is applied to various types of electronic devices (not shown), such as cellular phones (including smartphones), laptops (including tablet laptops), wearable terminals (including smartwatches), portable information terminals (including electronic books and personal digital assistants (PDAs)), portable game consoles, and digital photo frames. Accordingly, the liquid crystal panel 11 has a screen size approximately in a range from several inches to more than 10 inches and less than 20 inches, and is generally classified into a group of a small size or a medium and small size.

Components of the liquid crystal display device 10 other than the liquid crystal panel 11 are initially described. As illustrated in FIG. 2, the backlight device 12 at least includes a not-shown light source (e.g., cold-cathode tube, light emitting diode (LED), and organic electroluminescence (EL)), and a not-shown optical member. The optical member has a function of converting light emitted from the light source into planar light, for example. The case 13 is made of synthetic resin material having no conductivity (non-conductive material), and has a substantially box shape opened to the front. The case 13 accommodates the liquid crystal panel 11 and the backlight device 12 inside the case 13.

As illustrated in FIGS. 1 and 2, the cover glass 14 is so disposed as to cover the entire region of the liquid crystal panel 11 from the front to thereby protect the liquid crystal panel 11. The cover glass 14 constitutes a front external appearance of the liquid crystal display device 10. The cover glass 14 is made of a glass and plate-shaped base material which has a rectangular shape in the plan view, and is substantially transparent to exhibit excellent light translucency. The cover glass 14 is preferably made of toughened glass. For example, it is preferable that the toughened glass constituting the cover glass 14 is chemically toughened glass which includes a chemically toughened layer on a surface of a plate-shaped glass base material. This chemically toughened layer is produced by applying chemically toughening treatment to the surface of the glass base material. The cover glass 14 thus configured has high mechanical strength and shock resistance, and therefore more securely prevents damages and defects of the liquid crystal panel 11 disposed on the rear side of the cover glass 14.

As illustrated in FIG. 2, the housing 15 is made of metal material having conductivity (conductive material), such as iron and aluminum, and has a substantially box shape opened to the front. This opening is closed by the cover glass 14. The housing 15 includes a bottom portion 15a which faces an opposed surface of the liquid crystal panel 11 opposite to the display surface 11DS and covers the opposed surface, and a side portion 15b which rises from an outer circumferential end portion of the bottom portion 15a toward the front. The bottom portion 15a has a plate shape which is flat and parallel to the display surface 11DS of the liquid crystal panel 11, and has a shape and a size similar to those of the cover glass 14 in the plan view. The long side direction of the bottom portion 15a coincides with the Y axis direction, while the short side direction of the bottom portion 15a coincides with the X axis direction. The side portion 15b rises from each side of the outer circumferential end portion of the bottom portion 15a to form a substantially short-column overall shape. The rear surface of the outer circumferential end portion of the cover glass 14 is fixed to a rising tip portion of the side portion 15b. The housing 15 is fixed to the cover glass 14 by a fixing member such as a double sided tape.

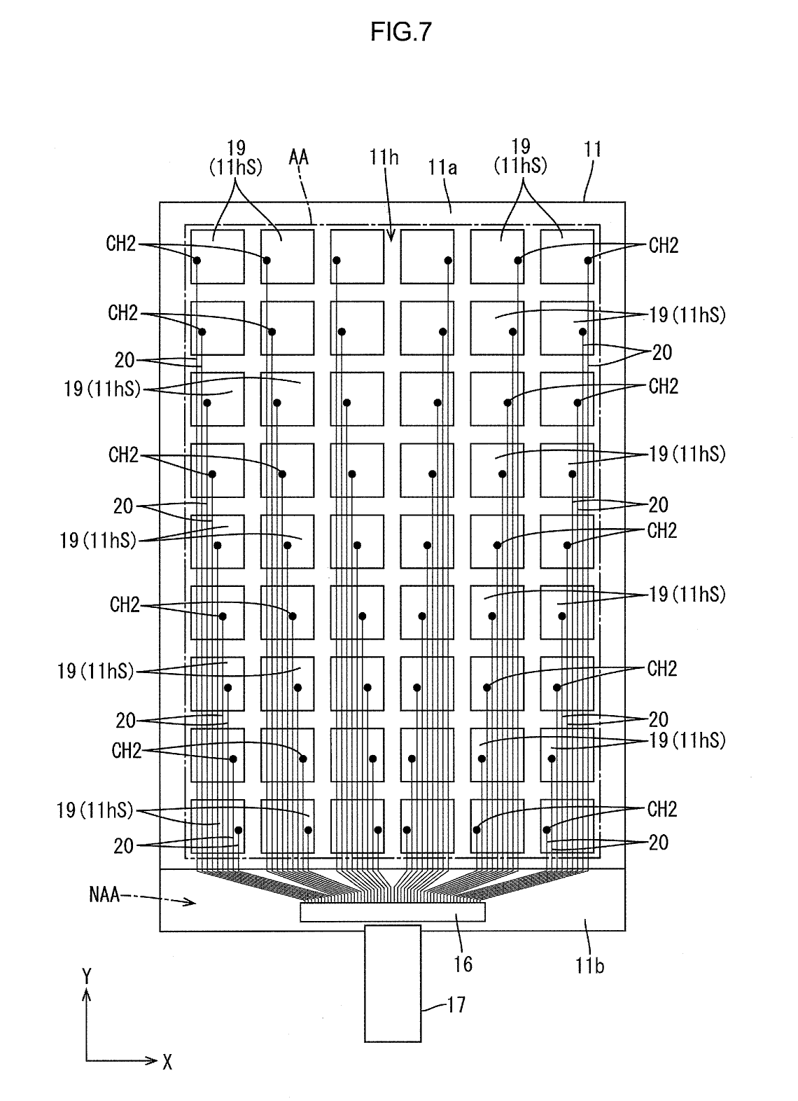

The liquid crystal panel 11 is now described. As illustrated in FIGS. 1 and 7, the liquid crystal panel 11 has a quadrangular overall shape (rectangular shape) which is vertically long. A display area (active area) AA on which an image is displayed is disposed at a position offset toward one end side (upper side in FIG. 7) in the long side direction. A driver 16 and a flexible substrate 17 are also attached to positions offset toward the other end side (lower side in FIG. 7) in the long side direction. An area other than the display area AA in the liquid crystal panel 11 is defined as a non-display area (non-active area) NAA where no image is displayed. The non-display area NAA is constituted by a substantially frame-shaped area surrounding the display area AA (picture frame portion of CF substrate 11a described below), and an area secured on the other end side in the long side direction (portion included in array substrate 11b described below and exposed without overlap with CF substrate 11a). In the respective areas of the non-display area NAA, the area secured on the other end side in the long side direction contains mounting areas (attachment areas) of the driver 16 and the flexible substrate 17. The short side direction of the liquid crystal panel 11 coincides with the X axis direction, while the long side direction of the liquid crystal panel 11 coincides with the Y axis direction. Furthermore, the normal direction to the display surface 11DS coincides with the Z axis direction. In addition, a control board (control circuit board) 18 corresponding to a signal supply source is connected to an end portion of the flexible substrate 17 opposite to the liquid crystal panel 11. A frame-shaped chain line in FIG. 7 indicates an external shape of the display area AA. The area outside the chain line corresponds to the non-display area NAA.

Sequentially described hereinafter are the members mounted on or connected to the liquid crystal panel 11 (driver 16, flexible substrate 17, and control board 18). As illustrated in FIG. 7, the driver 16 is constituted by a large-scale integration (LSI) chip including a driving circuit inside the LSI chip. The driver 16 is configured to operate in accordance with a signal supplied from the control board 18 to generate an output signal, and output the output signal toward the display area AA of the liquid crystal panel 11. The driver 16 has a quadrangular shape which is horizontally long in the plan view (elongated along short side of liquid crystal panel 11), and directly mounted on the non-display area NAA of the liquid crystal panel 11 (array substrate 11b described below), i.e., mounted by chip on glass (COG) mounting. The long side direction of the driver 16 coincides with the X axis direction (short side direction of liquid crystal panel 11), while the short side direction of the driver 16 coincides with the Y axis direction (long side direction of liquid crystal panel 11).

As illustrated in FIG. 7, the flexible substrate 17 includes a base material made of synthetic resin material (e.g., polyimide resin) exhibiting insulation and flexibility, and has a wiring pattern (not shown) of a large number of wires on the base material. One end portion of the flexible substrate 17 in the length direction is connected to the control board 18 as described above, while the other end portion (other end side) is connected to the array substrate 11b of the liquid crystal panel 11. Accordingly, the flexible substrate 17 is flexed in a folded manner to have a substantially U-shaped cross-sectional shape within the liquid crystal display device 10. The wiring pattern at each end of the flexible substrate 17 in the length direction is exposed to the outside to constitute a terminal portion (not shown). One and the other of the terminal portions are electrically connected to the control board 18 and the liquid crystal panel 11, respectively. In this manner, a signal supplied from the control board 18 is transmittable to the liquid crystal panel 11.

As illustrated in FIG. 7, the control board 18 is attached to the rear surface of the backlight device 12 (external surface opposite to liquid crystal panel 11) by screws or the like. Electronic parts are mounted on a paper phenol or glass epoxy resin substrate of the control board 18 to supply various types of signals to the driver 16. In addition, not-shown wires (conductive path) having a predetermined pattern are formed on the substrate. The one end portion (one end side) of the flexible substrate 17 is electrically and mechanically connected to the control board 18 via a not-shown anisotropic conductive film (ACF).

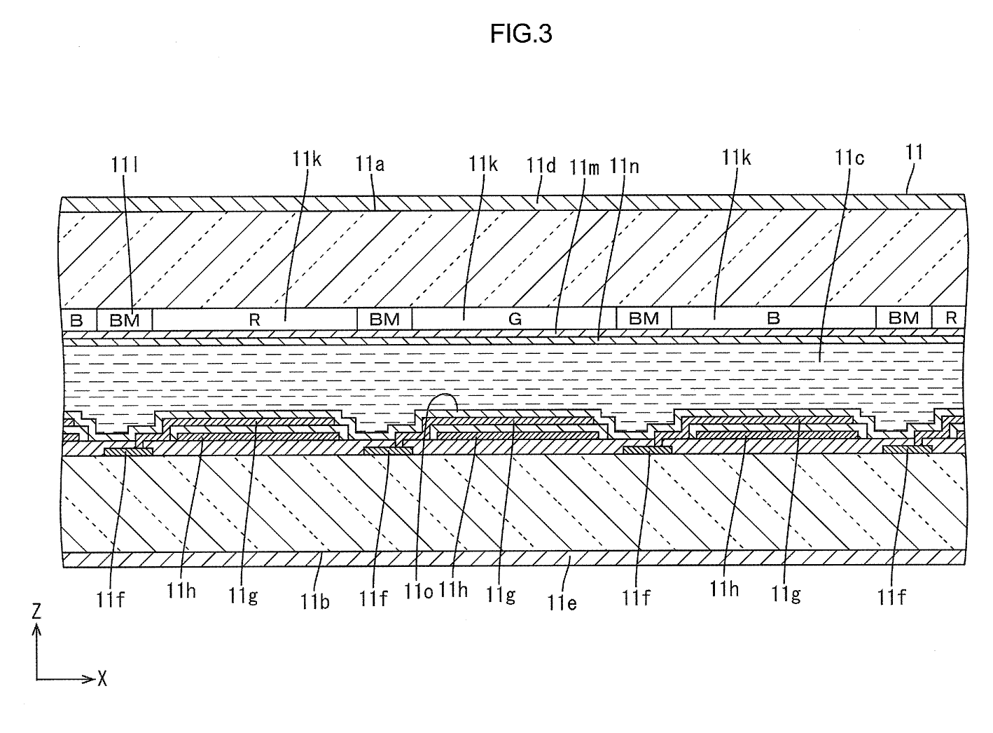

The liquid crystal panel 11 is again described. As illustrated in FIG. 3, the liquid crystal panel 11 includes a pair of substrates 11a and 11b, and a liquid crystal layer (medium layer) 11c disposed in an internal space between both the substrates 11a and 11b which contains liquid crystal molecules as substances changing optical characteristics in accordance with an electric field applied to the liquid crystal layer 11c. The liquid crystal layer 11c is surrounded by a not-shown seal portion interposed between both the substrates 11a and 11b for seal of the liquid crystal layer lic. The front side (front face side) substrate of the pair of substrates 11a and 11b is defined as a CF substrate (counter substrate) 11a, while the rear side substrate (rear face side) is defined as an array substrate (active matrix substrate, element substrate) 11b. Each of the CF substrate 11a and the array substrate 11b is produced by laminating various types of films on the inner surface side of a glass substrate made of glass. Polarizing plates 11d and lie are affixed to the outer surface sides of the substrates 11a and 11b, respectively.

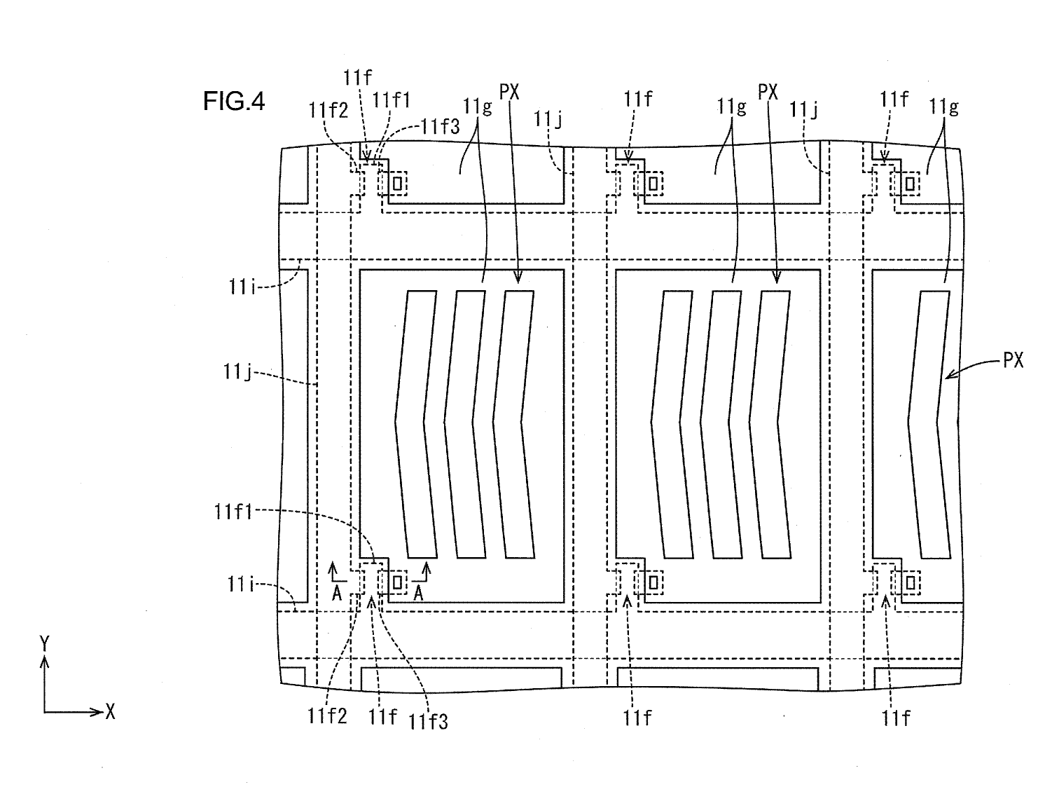

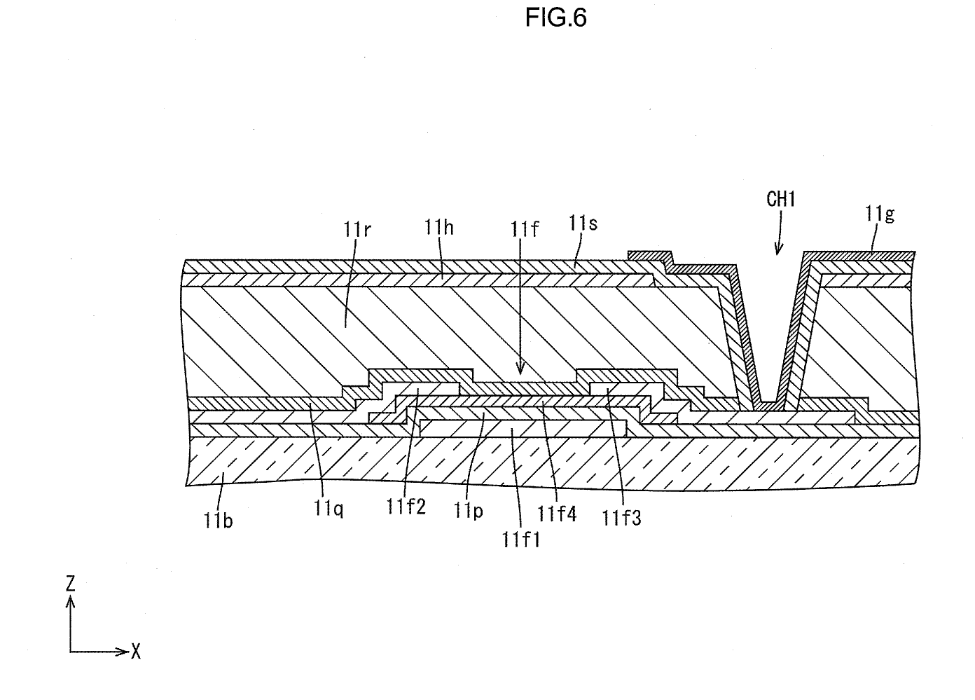

As illustrated in FIGS. 4 and 6, a large number of thin film transistors (TFTs: display elements) 11f corresponding to switching elements, and pixel electrodes 11g are arranged in a matrix (form of matrix) in the display area AA on the inner surface side of the array substrate lib (liquid crystal layer 11c side, opposed surface side facing CF substrate 11a). In addition, gate wires (scanning lines) 11i and source wires (data lines, signal lines) 11j forming a grid pattern are disposed around the TFTs 11f and the pixel electrodes 11g so as to surround the TFTs 11f and the pixel electrodes 11g. Gate insulation films lip are interposed between the gate wires 11i and the source wires 11j for insulation therebetween. The gate wires 11i and the source wires 11j are connected to gate electrodes 11f1 and source electrodes 11f2 of the TFTs 11f, respectively, while the pixel electrodes 11g are connected to drain electrodes 11f3 of the TFTs 11f. Each of the TFTs 11f is driven in accordance with various types of signals supplied to the gate wires 11i and the source wires 11j. Supply of potential to the pixel electrodes 11g is controlled based on this driving. Each of the TFTs 11f includes a channel portion 11f4 which connects the drain electrode 11f3 and the source electrode 11f2. The channel portion 11f4 is constituted by a semiconductor film made of oxide semiconductor material. The oxide semiconductor material constituting the channel portion 11f4 has approximately 20 to 50 times higher electron mobility than that of amorphous silicon material or the like, for example. Therefore, size reduction of the TFT 11f is easily achievable to obtain the maximum transmitted light volume (aperture ratio of pixel PX) of the pixel electrode 11g. Accordingly, this configuration is preferable in view of increase in definition and reduction of power consumption, for example. According to the present embodiment, the extending direction of the gate wires 11i coincides with the X axis direction, while the extending direction of the source wires 11j coincides with the Y axis direction.

As illustrated in FIGS. 4 and 6, each of the pixel electrodes 11g is disposed in a quadrangular area surrounded by the gate wire 11i and the source wire 11j, and includes a plurality of slits. Each of the pixel electrodes 11g is constituted by a transparent electrode film (upper layer side transparent electrode film) made of indium tin oxide (ITO) or zinc oxide (ZnO). Each of the pixel electrodes 11g is laminated on the upper layer side of a lower layer side interlayer insulation film 11q, a flattening film 11r, and an upper layer side interlayer insulation film 11s. A contact hole for TFT CH1 is opened in the lower layer side interlayer insulation film 11q, the flattening film 11r, and the upper layer side interlayer insulation film his at an overlapping position in the plan view between the drain electrode 11f3 of the TFT 11f and the lower layer side interlayer insulation film 11q, the flattening film 11r, and the upper layer side interlayer insulation film 11s. The pixel electrode 11g is electrically connected to the drain electrode 11f3 of the TFT 11f via the contact hole for TFT CH1. A common electrode 11h constituted by a transparent electrode film (lower layer side transparent electrode film) similarly to the pixel electrode 11g is interposed between the flattening film 11r and the upper layer side interlayer insulation film his. The common electrode 11h includes an opening at least at a position overlapping with the contact hole for TFT CH1. In this manner, both the pixel electrode 11g and the common electrode 11h are provided on the array substrate 11b. When a potential difference is produced between both the electrodes 11g and 11h, a fringing electric field (oblique electric field) containing components in the normal direction with respect to the plate surface of the array substrate 11b, as well as components along the plate surface of the array substrate 11b, are applied to the liquid crystal layer 11c. In other words, the liquid crystal panel 11 herein has a fringe field switching (FFS) mode, which is an improved operation mode of an in-plane switching (IPS) mode.

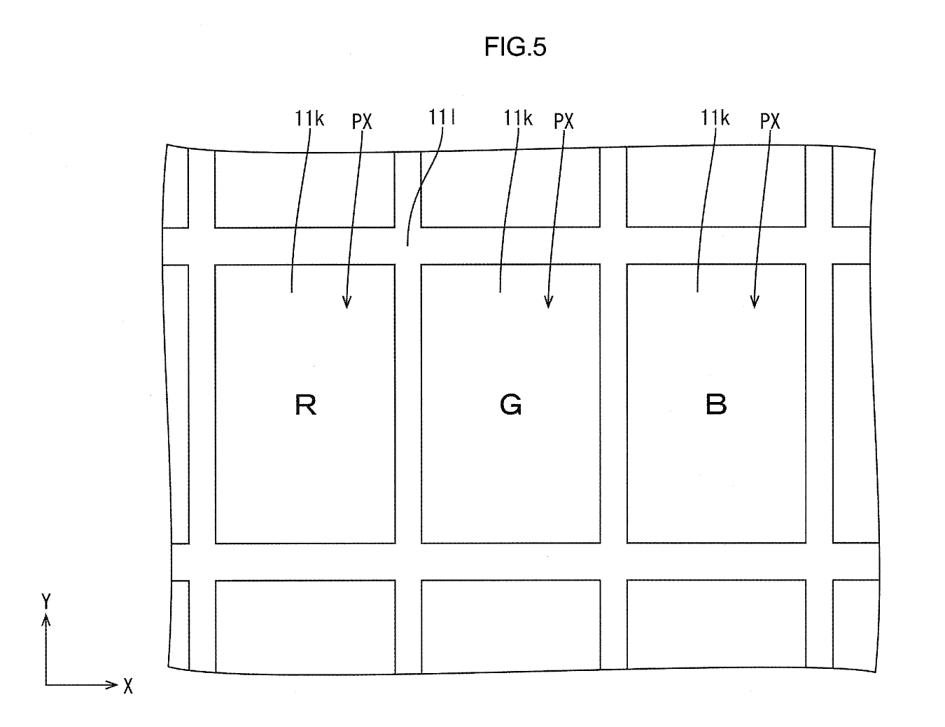

On the other hand, as illustrated in FIGS. 3 and 5, color filters 11k are provided on the inner surface side of the display area AA of the CF substrate 11a at positions facing the respective pixel electrodes 11g on the array substrate lib side. The color filters 11k are constituted by three colored portions in red (R), green (G), and blue (B) repeatedly arranged in a matrix. The respective colored portions (respective pixels PX) of the color filters 11k arranged in a matrix are separated from each other by a light shielding portion (black matrix) 11l. The light shielding portion 11l prevents color mixture of lights in respective colors passing through the respective colored portions. The light shielding portion 11l includes a grid-shaped portion having a grid shape in the plan view and separating the respective colored portions, and a frame-shaped portion having a frame shape (picture frame shape) in the plan view and surrounding the grid-shaped portion from the outer circumferential side. The grid-shaped portion of the light shielding portion 11l is disposed at a position overlapping with the gate wires 11i and the source wires 11j described above in the plan view. The frame-shaped portion of the light shielding portion 11l extends along a seal portion, and constitutes a vertically long and quadrangular frame shape in the plan view. An overcoat film (flattening film) 11m is overlapped on the inner surfaces of the color filters 11k and the light shielding portion 11l. Each of the pixels PX of the liquid crystal panel 11 is constituted by a set of the colored portion of the color filter 11k, and the pixel electrode 11g facing the colored portion. Each of the pixels PX includes a red pixel having an R colored portion, a green pixel having a G colored portion, or a blue pixel having a B colored portion in the color filter 11k. The respective pixels PX in three colors are repeatedly arranged in the row direction (X axis direction) on the plate surface of the liquid crystal panel 11 to constitute a pixel group. A large number of the pixel groups are arranged in the column direction (Y axis direction). In this manner, a large number of the pixels PX are arranged in a matrix within the display area AA of the liquid crystal panel 11. In addition, alignment films 11n and 11o for aligning liquid crystal molecules contained in the liquid crystal layer lic are provided as layers located innermost between both the substrates 11a and 11b and in contact with the liquid crystal layer 11c.

As described above, the liquid crystal panel 11 according to the present embodiment performs both the display function for displaying an image, and the position input function (position detection function) for detecting a position of input by the user (input position) based on the displayed image. A touch panel pattern for performing the position input function as one of these functions is formed within the liquid crystal panel 11 (in-cell form). This touch panel pattern is called a projection type electrostatic capacitive type touch panel pattern, and uses a self-capacitance detection system. As illustrated in FIG. 7, the touch panel pattern is provided on the array substrate lib as one of the pair of substrates 11a and 11b, and is constituted by a plurality of position detection electrodes 19 arranged in a matrix within the plane of the display surface 11DS of the array substrate lib. The position detection electrodes 19 are disposed in the display area AA of the array substrate 11b. Accordingly, the display area AA in the liquid crystal panel 11 is substantially equivalent to a touch area where an input position is detectable, while the non-display area NAA is substantially equivalent to a non-touch area where an input position is not detectable. Each of the position detection electrodes 19 produces electrostatic capacitance between the position detection electrode 19 and the conductive housing 15 of the liquid crystal display device 10. On the other hand, when the user moves a finger (position detection body) F as a conductive body close to the surface of the cover glass 14 to input a position based on an image of the display area AA visually recognized through the cover glass 14 of the liquid crystal display device 10, electrostatic capacitance is also produced between the finger F and the corresponding position detection electrode 19. In this case, the state of the electrostatic capacitance detected by the position detection electrode 19 located close to the finger F changes from the state before approach of the finger, wherefore the position detection electrode 19 located close to the finger F becomes different from the position detection electrode 19 located away from the finger F. Accordingly, the input position is detectable based on the difference thus produced. The position detection electrode 19 may also produce parasitic capacitance between the position detection electrode 19 and a conductive body other than the housing 15 and the finger F.

The respective position detection electrodes 19 are constituted by the common electrode 11h provided on the array substrate 11b. As illustrated in FIG. 7, the common electrode 11h is divided into a plurality of divisional common electrodes 11hS each having a grid shape in the plane of the display surface 11DS and electrically independent from each other. Each of the plurality of divisional common electrodes 11hS constitutes the corresponding position detection electrode 19. Accordingly, this configuration is preferable in view of simplification of the structure and cost reduction in comparison with a configuration including position detection electrodes separately from the common electrode 11h. A plurality of the position detection electrodes 19 (divisional common electrodes 11hS) are arranged in a matrix in each of the X axis direction and the Y axis direction in the plane of the display surface 11DS. Each of the position detection electrodes 19 has a substantially square shape in the plan view, and has a length of approximately 4 mm for each side. Accordingly, each of the position detection electrodes 19 is larger than each of the pixels PX (pixel electrodes 11g) in the plan view, and extends through a plurality of the pixels PX in each of the X axis direction and the Y axis direction. It is preferable that the number of the position detection electrodes 19 to be provided be approximately 500 for the liquid crystal panel 11 in a screen size of 5 inches, for example. FIG. 7 schematically illustrates an arrangement of the position detection electrodes 19. The specific number and positions of the position detection electrodes 19 to be provided may be appropriately changed from those depicted in the figure.

Each of a plurality of wires 20 is individually connected to the corresponding one of the plurality of position detection electrodes 19. Each of the wires 20 is constituted by a metal film interposed between the lower layer side interlayer insulation film 11q and the flattening film 11r (see FIG. 6), for example, and is connected to the corresponding position detection electrode 19 (divisional common electrode 11hS) through a contact hole for position detection electrode CH2 opened in the flattening film 11r. Each of the wires 20 linearly extends in the Y axis direction, i.e., the extension direction of the source wire 11j in the display area AA, and is so disposed as to overlap with the source wire 11j (light shielding portion 11l) in the plan view, and as not to overlap with the pixel PX. In this manner, decrease in the aperture ratio of the pixel PX by the presence of the wire 20 is avoided. While one end of the wire 20 is connected to the position detection electrode 19 in the display area AA via the contact hole for position detection electrode CH2 described above, the other end of the wire 20 is connected to the driver 16 in the non-display area NAA. The driver 16 connected to the wire 20 is allowed to drive the position detection electrode 19 via the wire 20. More specifically, the driver 16 is configured to drive the TFT 11f for image display, and drive the position detection electrode 19 for position detection to perform both the display function and the position detection function. As described above, each of the plurality of wires 20 connected to the driver 16 is individually associated with the corresponding one of the plurality of position detection electrodes 19. Accordingly, when a change is produced in electrostatic capacitance detected in specific one or a plurality of the particular position detection electrodes 19 included in the plurality of position detection electrodes 19 driven by the driver 16 as a change not detectable in the other position detection electrodes 19, the position detection electrode 19 corresponding to the changed electrostatic capacitance can be specified based on the wire 20 associated with the corresponding position detection electrode 19. Therefore, specification and detection of an input position are easily achievable. Accordingly, this configuration is preferable in view of increase in position detection sensitivity and pressure detection sensitivity described below, and also in view of detection of multi-touch at two or more input positions.

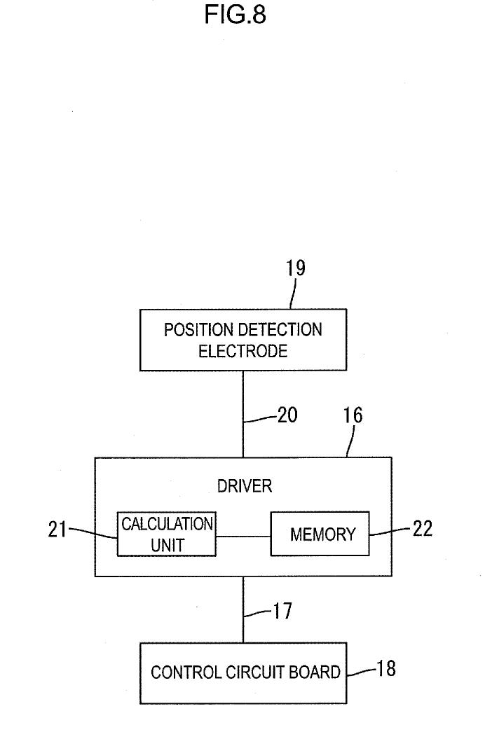

The liquid crystal display device 10 according to the present embodiment is also configured to detect a pressure associated with an action (pressing action) performed by the user to depress the liquid crystal panel 11 in the normal direction (Z axis direction) of the display surface 11DS, as well as detection of a two-dimensional input position input by the user to the plane of the display screen 11DS of the liquid crystal panel 11. For achieving detection of the pressure, the driver 16 according to the present embodiment includes a calculation unit 21 which calculates the pressure in the normal direction to the display surface 11DS based on a difference of a signal associated with electrostatic capacitance detected when a position change associated with an input position of the finger F of the user and detected by the position detection electrode 19 falls within a specified range as illustrated in FIG. 8. There is a possibility that a pressing action is currently performed by the finger F of the user when a position change associated with an input position of the finger F detected by the position detection electrode 19 falls within a specified range. When the finger F performs the pressing action herein, the liquid crystal panel 11 comes into a flexing state. In addition, the built-in position detection electrode 19 shifts to approach the bottom portion 15a of the housing 15 so disposed as to cover the surface of the liquid crystal panel 11 opposite to the display surface 11DS. As a result, electrostatic capacitance between the position detection electrode 19 and the housing 15 increases. In this case, the calculation unit 21 calculates a difference of a signal associated with the electrostatic capacitance detected when the position change associated with the input position of the finger F and detected by the position detection electrode 19 falls within the specified range. The calculated difference corresponds to a variation in the signal associated with the electrostatic capacitance as a result of the pressing action of the finger F. Based on the difference, the calculation unit 21 calculates the pressure applied to the liquid crystal panel 11 in accordance with the pressing action by the finger F. As apparent from above, the pressure associated with a pressing action is detectable as well as an input position on the display surface 11DS of the liquid crystal panel 11 without the necessity of a sensor for pressure detection or the like. Moreover, the configuration that the calculation unit 21 is included in the driver 16 is preferable in view of increasing a pressure calculation speed.

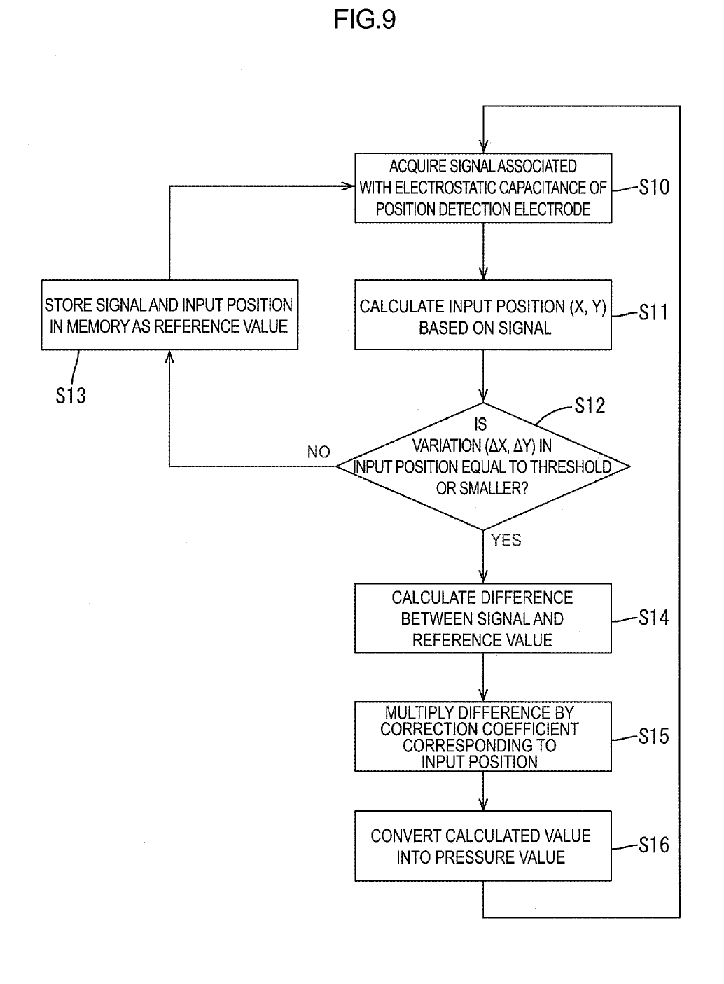

In addition to the calculation unit 21, the driver 16 includes a memory 22 which stores, as a reference value, a signal associated with electrostatic capacitance acquired when a variation associated with an input position detected by the position detection electrode 19 exceeds a threshold as illustrated in FIG. 8. The memory 22 is a non-volatile recording medium, such as a flash memory. As illustrated in FIG. 9, the calculation unit 21 is configured to calculate a pressure based on a difference between the reference value stored in the memory 22, and a signal associated with electrostatic capacitance acquired when a variation associated with an input position and detected by the position detection electrode 19 does not exceed the threshold. When the variation associated with the input position and detected by the position detection electrode 19 exceeds the threshold, it is determined that the input position of the finger F is in motion and the pressing action is not performed. In this case, a signal associated with acquired electrostatic capacitance is stored in the memory 22 as a reference value. On the other hand, when the variation associated with the input position and detected by the position detection electrode 19 does not exceed the threshold, it is determined that the pressing action is performed in a stop state of the input position of the finger F. In this case, the calculation unit 21 calculates a difference between a signal associated with acquired electrostatic capacitance and the reference value stored in the memory 22, and calculates a pressure applied to the liquid crystal panel 11 in accordance with the pressing action based on the calculated difference. As described above, a reference value of a signal associated with electrostatic capacitance is acquired based on a variation associated with an input position and detected by the position detection electrode 19 before calculating the pressure. Because the pressure can be achieved based on an appropriate reference value, more appropriate pressure can be achieved.

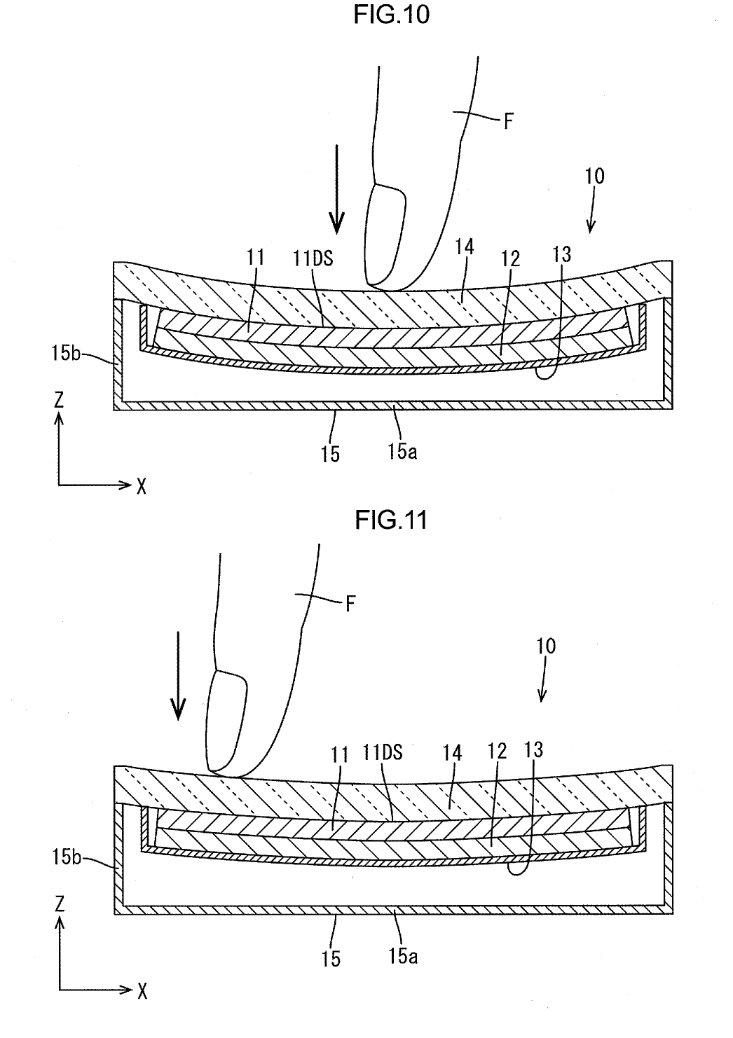

Moreover, the calculation unit 21 is configured to calculate the the pressure by multiplying a correction coefficient corresponding to an input position on the display surface 11DS of the liquid crystal panel 11 by a difference of a signal associated with electrostatic capacitance detected when a position change associated with the input position of the finger F falls within the specified range as illustrated in FIG. 9. The correction coefficient is stored in the memory 22, and determined in the following manner. A displacement magnitude of the position detection electrode 19 produced when the liquid crystal panel 11 flexes by a pressing action with the finger F varies depending on an input position on the display surface 11DS. More specifically, when the pressure applied to the liquid crystal panel 11 by the pressing action with the finger F is fixed, for example, the displacement magnitude of the position detection electrode 19 tends to become relatively larger in a central region of the display surface 11DS by higher flexibility of the central region of the liquid crystal panel 11 as illustrated in FIG. 10. However, the displacement magnitude of the position detection electrode 19 tends to become relatively smaller in an end region of the display surface 11DS by lower flexibility of the end region of the liquid crystal panel 11 as illustrated in FIG. 11. Accordingly, the correction coefficient multiplied by the difference associated with electrostatic capacitance for calculation of the pressure is set to a relatively small value when the input position lies in the central region of the display surface 11DS, but is set to a relatively large value when the input position lies in the end region of the display surface 11DS. In other words, the correction coefficient has opposite correlation with distribution of a flexible volume of the liquid crystal panel 11 produced by an input position in the plane of the display surface 11DS and a displacement magnitude of the position detection electrode 19 caused by the flexing. In this case, as illustrated in FIG. 10, the difference associated with electrostatic capacitance relatively increases by a large displacement magnitude of the position detection electrode 19 as a result of a relatively large flexible volume of the liquid crystal panel 11 at the time of an input position in the central region of the display surface 11DS, in comparison with an input position in the end region of the display surface 11DS. However, the pressure calculated by multiplying the difference by a correction coefficient set to a small value does not become excessively large. On the other hand, the difference associated with electrostatic capacitance relatively decreases by a small displacement magnitude of the position detection electrode 19 as a result of a relatively small flexible volume of the liquid crystal panel 11 at the time of an input position in the end region of the display surface 11DS, in comparison with an input position in the central region of the display surface 11DS. However, the pressure calculated by multiplying the difference by a correction coefficient set to a larger value does not become excessively small. Accordingly, the pressure calculated by the calculation unit 21 becomes appropriate for any input position.

The present embodiment has the structure described above. An operation of the present embodiment is hereinafter described. The liquid crystal display device 10 in the present embodiment has the position input function. Accordingly, the user of the liquid crystal display device 10 is allowed to input a position by using the finger F based on an image displayed on the display surface 11DS of the liquid crystal panel 11. The common electrode 11h provided on the array substrate 11b of the liquid crystal panel 11 also functions as the position detection electrodes 19. Accordingly, while common potential (reference potential) corresponding to a reference for potential of the pixel electrodes 11g is applied by the driver 16 to the common electrode 11h during display, potential for producing electrostatic capacitance between the common electrode 11h and the housing 15 or the finger F is applied by the driver 16 to the common electrode 11h during position detection. In other words, the driver 16 controls driving of the liquid crystal panel 11 while dividing a unit period into a display period and a position detection period.

During the display period, scanning signals are supplied from the driver 16 to the respective gate wires 11i, data signals are supplied from the driver 16 to the respective source wires 11j, and common potential signals are supplied from the driver 16 to the respective wires 20. When the respective TFTs 11f belonging to rows selected by the scanning signals supplied to the respective gate wires 11i are turned on, voltage corresponding to the data signals supplied to the respective source wires 11j is applied to the pixel electrodes 11g via the channel portions 11f4 of the TFTs 11f. Identical common potential is collectively applied to the respective divisional common electrodes 11hS of the common electrode 11h at the same timing in accordance with the common potential signals supplied to the respective wires 20. Display with predetermined gradation is achieved at the respective pixels PX based on potential differences between the respective pixel electrodes 11g and the common electrode 11h. As a result, a predetermined image is displayed on the display surface 11DS of the liquid crystal panel 11.

During the position detection period, position detection driving signals are supplied from the driver 16 to the respective wires 20. The respective position detection electrodes 19 driven in accordance with the position detection driving signals supplied to the respective wires 20 produce predetermined electrostatic capacitance between the position detection electrodes 19 and the housing 15. In this case, electrostatic capacitance is produced between the finger F and the position detection electrode 19 close to the finger F when the user of the liquid crystal display device 10 inputs a position by using the finger F in the plane of the display surface 11DS of the liquid crystal panel 11 via the cover glass 14. More specifically, electrostatic capacitance is produced not only between the housing 15 and the position detection electrode 19 close to the finger F, but also between the finger F and the position detection electrode 19 close to the finger F. Accordingly, electrostatic capacitance larger than electrostatic capacitance of the position detection electrode 19 away from the finger F is produced by the position detection electrode 19 close to the finger F. When the driver 16 detects electrostatic capacitance of the respective position detection electrodes 19 via the respective wires 20, the driver 16 extracts changed electrostatic capacitance from the detected electrostatic capacitance, and acquires information about the position of the position detection electrode 19 on the display surface 11DS, as the position detection electrode 19 connected to the wire 20 having transmitted the changed electrostatic capacitance. In this manner, the input position of the finger F of the user is detectable.

The liquid crystal display device 10 described herein is configured to detect the pressure in the following manner when a pressing action for pressing the liquid crystal panel 11 in the Z axis direction is performed by using the finger F of the user. Initially, as illustrated in FIG. 9, the calculation unit 21 acquires a signal associated with electrostatic capacitance of the position detection electrode 19 corresponding to an input position of the finger F (step S10), and calculates the input position based on the acquired signal (step S11). In step S11, the calculation unit 21 calculates coordinate information (x, y) corresponding to the input position on the display surface 11DS of the liquid crystal panel 11. Subsequently, the calculation unit 21 calculates a variation in the input position, and determines whether or not the calculated change volume is a threshold or smaller (step S12). The calculation unit 21 calculates, as the variation in the input position, a difference (Δx, Δy) by subtracting coordinate information (x1, y1) corresponding to the reference value of the input position from coordinate information (x2, y2) corresponding to the acquired input position. The threshold of the change volume is set to any value which is smaller than a change volume during a shift of the input position of the finger F, and larger than a change volume during a stop of the input position of the finger F. When input of the position is initial input, the coordinate information (x2, y2) corresponding to the acquired input position is equivalent to the difference (Δx, Δy) and exceeds the threshold of the change volume. When the variation in the input position exceeds the threshold, it is determined that the input position is in motion and a pressing action is not performed. In this case, the calculation unit 21 stores the acquired signal and input position in the memory 22 as a reference value (step S13). Thereafter, the process returns to step S10.

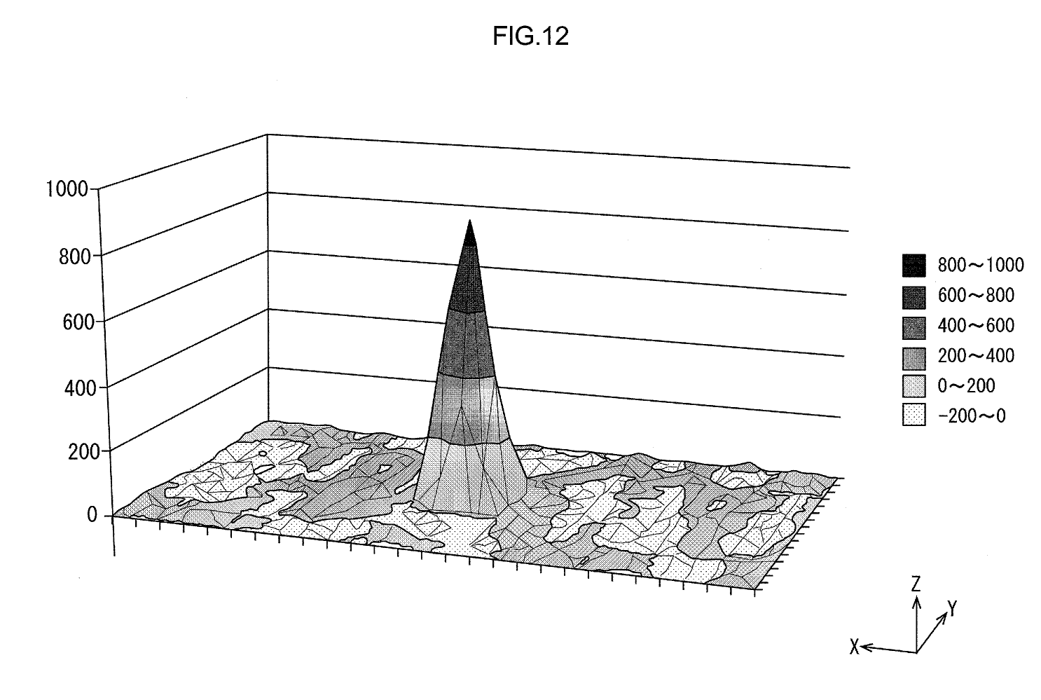

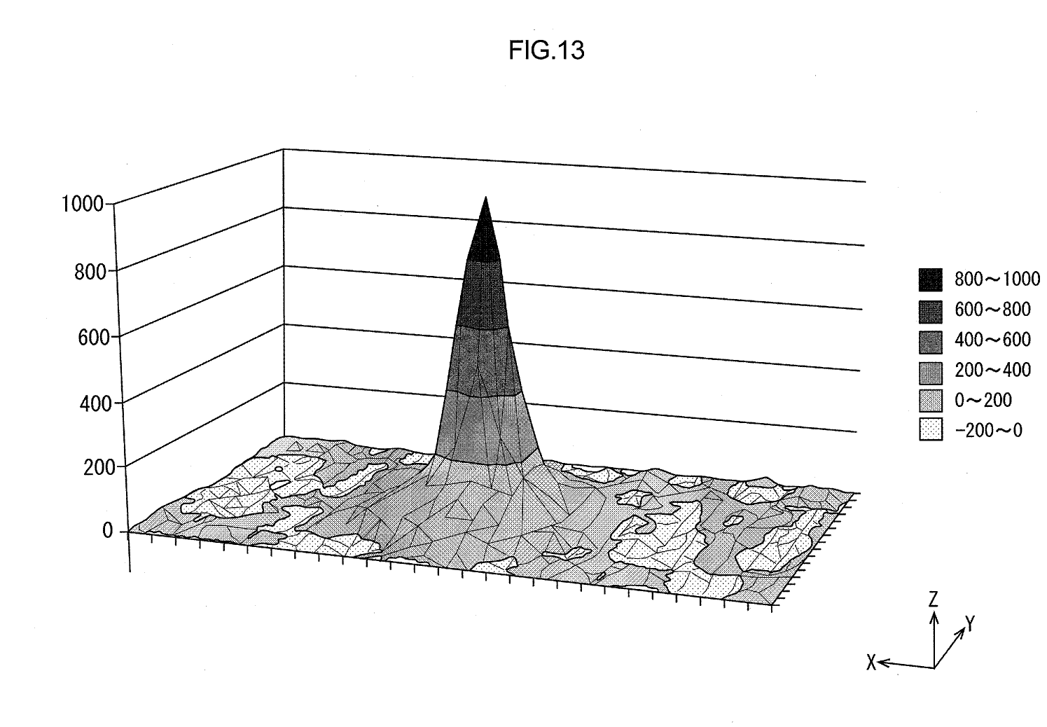

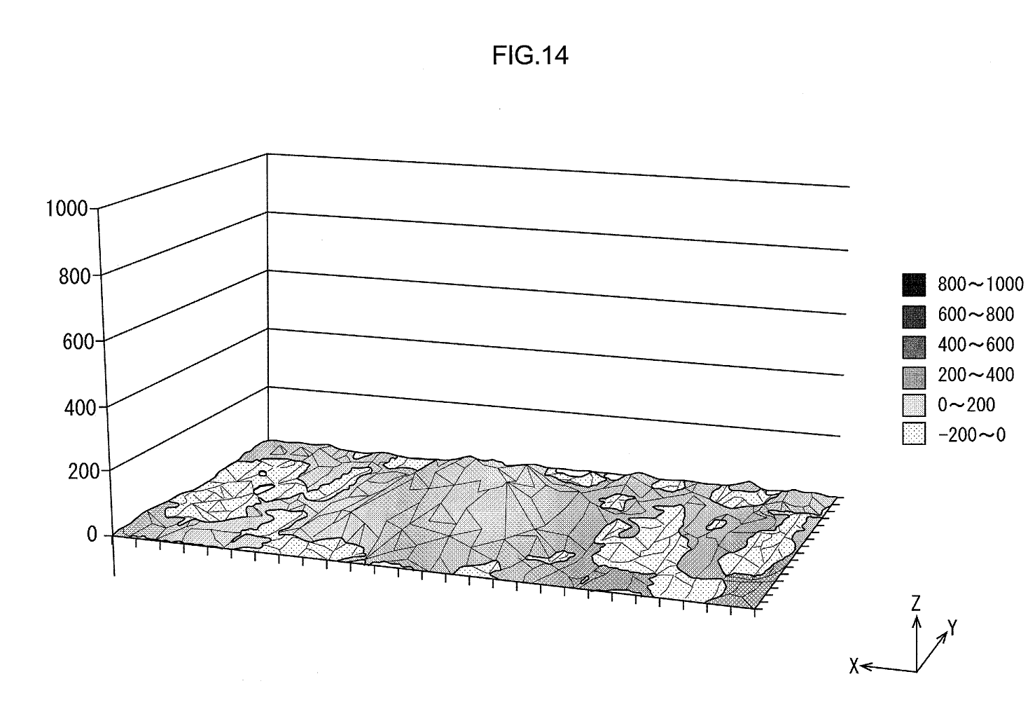

When the variation in the input position is equal to or smaller than the threshold, it is determined that there is a possibility of the presence of the pressing action in a stop state of the input position as illustrated in FIG. 9. In this case, the calculation unit 21 calculates a difference between the acquired signal and the reference value (step S14). The difference calculated herein is calculated by subtracting a signal of electrostatic capacitance prior to the pressing action by the finger F (see FIG. 12) from a signal of electrostatic capacitance after the pressing action by the finger F (see FIG. 13), and therefore reflects a change of electrostatic capacitance produced by the pressing action (see FIG. 14). Each of FIGS. 12 to 14 is a graph indicating an input position of the finger F and a signal of electrostatic capacitance. In each of the figures, the X axis direction and the Y axis direction indicate an input position in the plane of the display surface 11DS, while the Z axis direction indicates a signal of electrostatic capacitance. A numerical value corresponding to a signal of electrostatic capacitance in each of FIGS. 12 to 14 is a value without unit obtained by converting analog data about electrostatic capacitance of the position detection electrode 19 into digital data.

Subsequently, as illustrated in FIG. 9, the calculation unit 21 multiplies the difference by a correction coefficient corresponding to the input position (step S15). In this case, the calculation unit 21 extracts a correction coefficient associated with the coordinate information (x2, y2) corresponding to the input position from the correction coefficients stored in the memory 22, and multiplies the difference by the extracted correction coefficient. This correction coefficient has opposite correlation with distribution of a flexible volume of the liquid crystal panel 11 caused by the input position in the plane of the display surface 11DS, and a displacement magnitude of the position detection electrode 19 produced by the flexing. Accordingly, the value calculated by multiplying the difference by the correction coefficient becomes appropriate for any input position. Thereafter, the calculation unit 21 converts the calculated value into a pressure value (step S16). The memory 22 stores a database which associates calculated values corresponding to differences with pressure values. Accordingly, the calculation unit 21 converts the calculated value into a pressure value with reference to this database. After the pressure value is acquired, the process again returns to step S10.

As described above, the liquid crystal display device (display device with position input function) 10 according to the present embodiment includes: the liquid crystal panel (display panel) 11; the housing 15 accommodating the liquid crystal panel 11, made of conductive material, and so disposed as to cover at least a surface of the liquid crystal panel 11 opposite to a display surface 11DS of the display panel 11; the position detection electrode 19 provided on the liquid crystal panel 11, and configured to produce electrostatic capacitance between the position detection electrode 19 and the housing 15 and between the position detection electrode 19 and the finger (position input body) F that inputs a position in the plane of the display surface 11DS, and detect an input position of the finger F; and the calculation unit 21 configured to calculate the pressure in the normal direction to the display surface 11DS based on a difference of a signal associated with the electrostatic capacitance detected when a position change associated with the input position of the finger F and detected by the position detection electrode 19 falls within a specified range.

According to this configuration, an input position of the finger F is detected by the position detection electrode 19 which produces electrostatic capacitance between the position detection electrode 19 and the housing 15 made of conductive material and between the position detection electrode 19 and the finger F when a position is input to the plane of the display surface 11DS of the liquid crystal panel 11 by the finger F. There is a possibility of the presence of an action for depressing the liquid crystal panel 11 in the normal direction to the display surface 11DS (pressing action) by the finger F when a position change associated with the input position of the finger F and detected by the position detection electrode 19 falls within the specified range. When the finger F performs the pressing action herein, the liquid crystal panel 11 comes into a flexing state. In addition, the position detection electrode 19 provided on the liquid crystal panel 11 shifts to approach the housing 15 so disposed as to cover the surface of the liquid crystal panel 11 opposite to the display surface 11DS. As a result, the electrostatic capacitance between the position detection electrode 19 and the housing 15 increases. In this case, the calculation unit 21 calculates a difference of a signal associated with the electrostatic capacitance detected when the position change associated with the input position of the finger F and detected by the position detection electrode 19 falls within the specified range. The calculated difference corresponds to a variation in the signal associated with the electrostatic capacitance produced by the pressing action of the finger F. The pressure in the normal direction to the display surface 11DS of the liquid crystal panel 11 is calculated based on this difference. As apparent from above, the pressure associated with a pressing action is detectable as well as an input position on the display surface 11DS of the liquid crystal panel 11 without the necessity of a sensor for the pressure detection or the like.

Moreover, the calculation unit 21 calculates the pressure by multiplying a difference by a correction coefficient corresponding to an input position on the display surface 11DS. A displacement magnitude of the position detection electrode 19 caused by flexing of the liquid crystal panel 11 as a result of a pressing action by finger F varies in accordance with an input position on the display surface 11DS. The displacement magnitude becomes relatively larger in a central region of the display surface 11DS, and becomes relatively smaller in an end region of the display surface 11DS. Accordingly, the calculation unit 21 multiplies a difference associated with electrostatic capacitance by a correction coefficient corresponding to an input position on the display surface 11DS at the time of calculation of the pressure. This correction coefficient is derived based on an input position on the display surface 11DS. The correction coefficient tends to be relatively small when the input position lies in the central region of the display surface 11DS, for example, but tends to be relatively large when the input position lies in the end region of the display surface 11DS. By adoption of the correction coefficient determined as above, the pressure calculated by the calculation unit 21 becomes appropriate for any input position.

There is provided the memory 22 that stores, as a reference value, a signal associated with electrostatic capacitance acquired when a variation associated with an input position and detected by the position detection electrode 19 exceeds a threshold. The calculation unit 21 calculates the pressure based on a difference between a signal associated with electrostatic capacitance acquired when the variation does not exceed the threshold, and the reference value stored in the memory 22. When the variation associated with the input position and detected by the position detection electrode 19 exceeds the threshold, the input position of the finger F is in motion. In this case, the memory 22 stores a signal associated with acquired electrostatic capacitance as a reference value. On the other hand, when the variation associated with the input position and detected by the position detection electrode 19 does not exceed the threshold, there is a possibility of the presence of the pressing action in a stop state of the input position of the finger F. In this case, the calculation unit 21 calculates the pressure based on a difference between a signal associated with acquired electrostatic capacitance and the reference value stored in the memory 22. As described above, a reference value of a signal associated with electrostatic capacitance is acquired based on a variation associated with an input position and detected by the position detection electrode 19 before calculating the pressure. Because the pressure can be achieved based on an appropriate reference value, more appropriate pressure can be achieved.

The driver 16 which drives the position detection electrode 19 is mounted on the liquid crystal panel 11. The calculation unit 21 is included in the driver 16. According to this configuration, the pressure is calculated by the calculation unit 21 included in the driver 16 mounted on the liquid crystal panel 11. This configuration is therefore preferable in view of increasing a pressure calculation speed.

The position detection electrode 19 is formed within the liquid crystal panel 11. This configuration is preferable in view of thickness reduction or the like in comparison with a configuration which forms the position detection electrode 19 in a touch panel as a component separated from the liquid crystal panel 11.

The liquid crystal panel 11 includes at least the pixel electrode 11g to which voltage is applied with gradation corresponding to an image displayed on the display surface 11DS, and the common electrode 11h to which common potential is applied. The common electrode 11h includes a plurality of divisional common electrodes 11hS disposed in a matrix in the plane of the display surface 11DS, and constituting the position detection electrode 19.

According to this configuration, a predetermined image is displayed on the display surface 11DS of the liquid crystal panel 11 based on a potential difference between the pixel electrode 11g and the common electrode 11h. The common electrode 11h is divided into the plurality of divisional common electrodes 11hS which constitute the position detection electrode 19. Accordingly, this configuration is preferable in view of simplification of the structure, cost reduction or the like in comparison with a configuration which provides the position detection electrode 19 separately from the common electrode 11h.

The liquid crystal panel 11 includes at least the plurality of wires 20 each of which is individually connected to the corresponding one of the plurality of divisional common electrodes 11hS. According to this configuration, identical common potential is applied to the plurality of divisional common electrodes 11hS via the plurality of wires 20 for display of an image on the display surface 11DS. On the other hand, for position detection and pressure detection, individual position detection signals are supplied to the plurality of divisional common electrodes 11hS via the plurality of wires 20 so as to specify an input position of the finger F. Accordingly, this configuration is preferable in view of increasing position detection sensitivity and pressure detection sensitivity, and also in view of detection of multi-touch at two or more input positions.

The liquid crystal panel 11 includes at least the pair of substrates 11a and 11b overlapped with the liquid crystal panel 11 on the housing 15 side and on the opposite side, respectively. The position detection electrode 19 is provided on the array substrate (substrate) 11b disposed on the housing 15 side as one of the pair of substrates 11a and 11b. According to this configuration, the distance between the position detection electrode 19 and the housing 15 decreases in comparison with a configuration including the position detection electrode 19 on the CF substrate 11a opposite to the housing 15 side. Accordingly, position detection sensitivity and pressing force detection sensitivity further improve.

### Second Embodiment

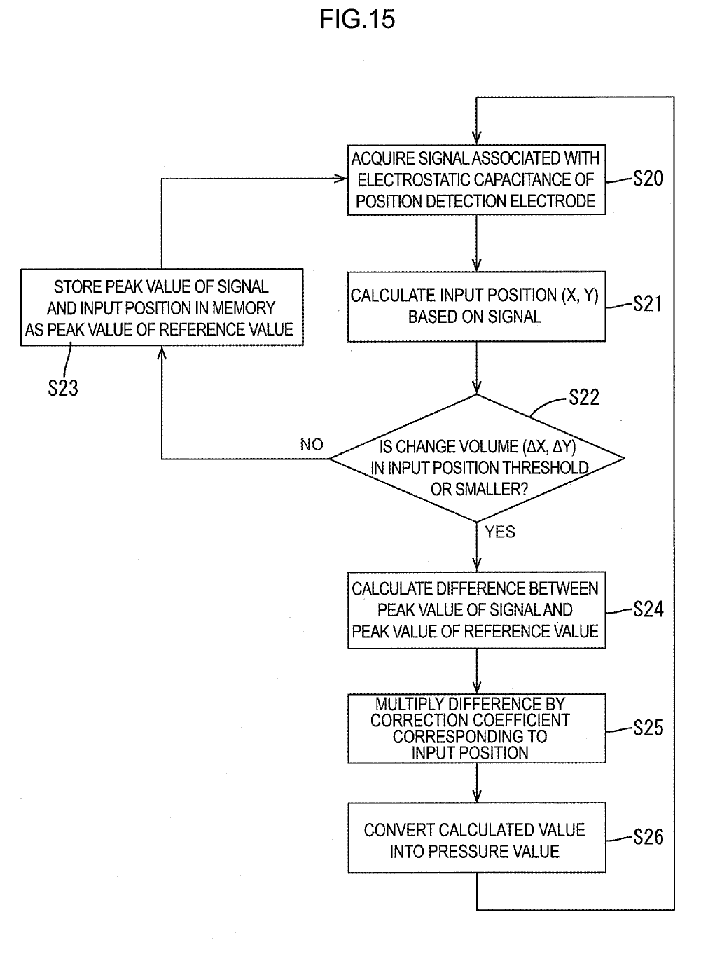

A second embodiment according to the present invention is now described with reference to FIG. 15. According to the second embodiment, a peak value in a signal of electrostatic capacitance is stored in a memory. The structures, operations, and effects similar to those in the first embodiment described above are not repeatedly explained.

As illustrated in FIG. 15, the memory according to the present embodiment stores a peak value in a signal of electrostatic capacitance as a peak value of a reference value in step S23. The signal of electrostatic capacitance and the peak value of the signal are touched upon herein. While the signal of electrostatic capacitance is indicated by the graph illustrated in each of FIGS. 12 to 14, the peak value of the signal is indicated by the highest value of the signal in the Z axis direction. More specifically, when determination is “NO” in step S22, a calculation unit extracts a peak value from the acquired signal, and stores the peak value and the input position in the memory as a reference value. In this case, the volume of information stored in the memory decreases in comparison with a configuration which stores the whole signal in the memory as described in the first embodiment. Accordingly, reduction of the memory size (storage capacity) is achievable. Subsequently, the calculation unit calculates a difference between the peak value in the signal of the electrostatic capacitance and the peak value of the reference value in step S24. Processing from step S20 to step S22 and from step S25 to step S26 other than the processing in step S23 and step S24 is similar to the corresponding processing from step S10 to step S12 and from step S15 to step S16 in the first embodiment described above.

According to the present embodiment described herein, the memory stores, as a reference value, a peak value of a signal associated with electrostatic capacitance acquired when a variation exceeds a threshold. According to this configuration, the volume of information stored in the memory decreases in comparison with a configuration which stores a whole signal associated with electrostatic capacitance. Accordingly, reduction of the memory size is achievable.

### Third Embodiment

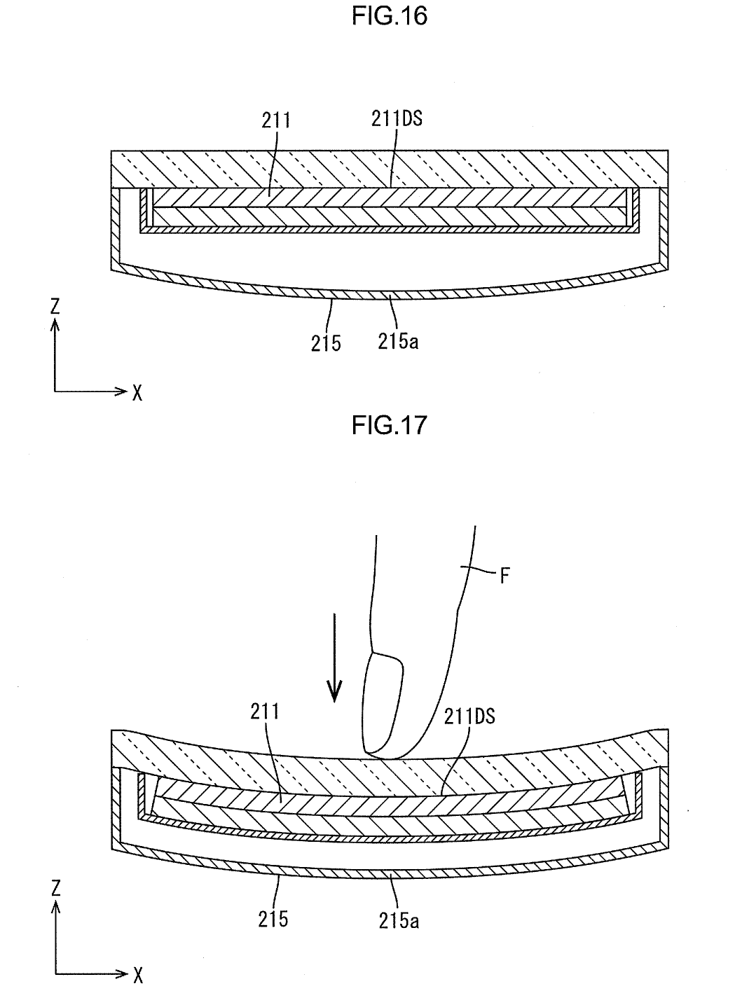

A third embodiment according to the present invention is now described with reference to FIG. 16 or FIG. 17. The third embodiment is different from the first embodiment in a structure of a housing 215. The structures, operations, and effects similar to those in the first embodiment described above are not repeatedly explained.

As illustrated in FIG. 16, the housing 215 according to the present embodiment includes a bottom portion 215a which has a shape curved such that a distance from a liquid crystal panel 211 gradually decreases from a central region of a display surface 211DS of the liquid crystal panel 211 toward an end region of the display surface 211DS. More specifically, the bottom portion 215a has a substantially spherical crown overall shape. The distance between the liquid crystal panel 211 and a portion of the bottom portion 215a overlapping with the center position of the display surface 211DS in the Z axis direction (normal direction to display surface 211DS) becomes the maximum, while the distance between the liquid crystal panel 211 and an outer circumferential end portion of the bottom portion 215a in the Z axis direction becomes the minimum. When the pressing force is constant, a displacement magnitude of a position detection electrode caused by a pressing action by a finger F tends to become relatively smaller in the end region of the display surface 211DS of the liquid crystal panel 211 than in the central region, and conversely tends to become relatively larger in the central region than in the end region (see FIG. 17). On the other hand, when the bottom portion 215a has a curved shape as described above, electrostatic capacitance produced between the bottom portion 215a and the position detection electrode becomes relatively larger in the end region of the display surface 211DS of the liquid crystal panel 211 than in the central region, and conversely becomes relatively smaller in the central region than in the end region. Accordingly, detection sensitivity for the pressure in the end region of the display surface 211DS improves, wherefore a difference between detection sensitivity in the end region and detection sensitivity in the central region decreases.

According to the present embodiment described above, the housing 215 includes the bottom portion 215a which covers the surface of the liquid crystal panel 211 opposite to the display surface 211DS. The bottom portion 215a has a shape curved such that the distance from the liquid crystal panel 211 gradually decreases from the central region of the display surface 211DS toward the end region. When the pressure is constant, a displacement magnitude of the position detection electrode caused by a pressing action by the finger F tends to become relatively smaller in the end region of the display surface 211DS of the liquid crystal panel 211 than in the central region. On the other hand, when the bottom portion 215a has a curved shape as described above, electrostatic capacitance produced between the bottom portion 215a and the position detection electrode becomes relatively larger in the end region of the display surface 211DS of the liquid crystal panel 211 than in the central region. Accordingly, detection sensitivity for pressing force in the end region of the display surface 211DS improves and thus a difference between detection sensitivity in the end region and detection sensitivity in the central region decreases.

### Fourth Embodiment

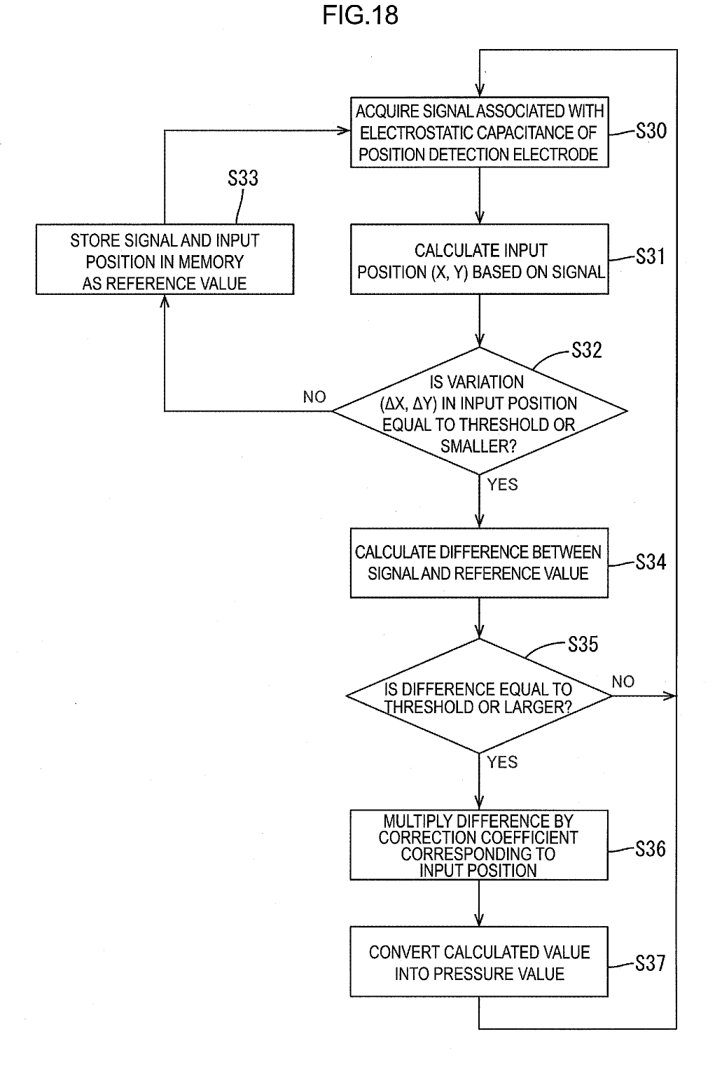

A fourth embodiment according to the present invention is now described with reference to FIG. 18. The fourth embodiment is different from the first embodiment in additional determination of whether or not a difference between a signal of electrostatic capacitance and a reference value is a threshold or larger. The structures, operations, and effects similar to those in the first embodiment described above are not repeatedly explained.

As illustrated in FIG. 18, a calculation unit according to the present embodiment initially calculates a difference between a signal of electrostatic capacitance and a reference value in step S34, and then determines whether or not the difference is a threshold or larger (step S35). The threshold in step S35 is set to the minimum of a variation in electrostatic capacitance which can be produced in accordance with a pressing action, for example. Accordingly, it is determined that a difference is due to detection errors of electrostatic capacitance, for example, when the difference does not exceed the threshold in step S34. In this case, the process returns to step S30 without calculation of the pressure by the calculation unit. In this manner, the absence of the pressing action is detectable. When the difference is the threshold or larger in step S34, the calculation unit multiplies the difference by a correction coefficient corresponding to an input position (step S36), and then converts the calculated value into a pressure value (step S37). In this manner, the presence or absence of the pressing action is detectable. The processing from step S30 to step S34, step S36, and step S37 is similar to the processing from step S10 to step S16 in the first embodiment described above.

According to the present embodiment described above, the calculation unit does not calculate the pressure when a difference does not exceed a threshold, but calculates the pressure when a difference exceeds the threshold. According to this configuration, the calculation unit does not calculate the pressure when the difference associated with the electrostatic capacitance detected by the position detection electrode does not exceed the threshold. Accordingly, the absence of the pressing action is detectable based on the omission of the calculation. On the other hand, when the difference between the maximum value of electrostatic capacitance detected by the position detection electrode and the reference value exceeds the threshold, the calculation unit calculates the pressure. Accordingly, the presence of the pressing action is detectable based on the execution of the calculation. In this manner, the presence or absence of the pressing action is detectable.

### Fifth Embodiment

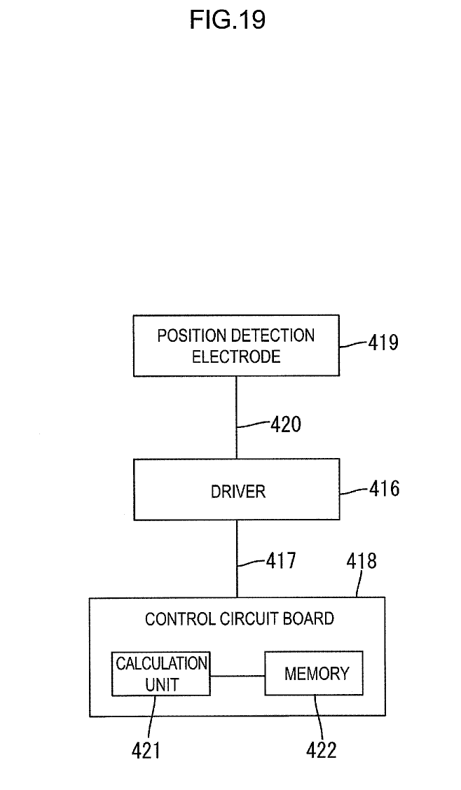

A fifth embodiment according to the present invention is now described with reference to FIG. 19. The fifth embodiment is different from the first embodiment in positions of a calculation unit 421 and a memory 422. The structures, operations, and effects similar to those in the first embodiment described above are not repeatedly explained.

As illustrated in FIG. 19, the calculation unit 421 and the memory 422 according to the present embodiment are included in a control board 418. The calculation unit 421 is connected to a position detection electrode 419 via a wire 420, a driver 416, and a flexible substrate 417. In this configuration, the driver 416 need not include the calculation unit 421 and the memory 422. Accordingly, this configuration is preferable in view of size reduction of the driver 416.

According to the present embodiment described herein, there are provided the flexible substrate (connection part) 417 one end of which is connected to the liquid crystal panel, and the control board (control circuit board) 418 connected to the other end of the flexible substrate 417. The calculation unit 421 is included in the control board 418. In this case, the calculation unit 421 included in the control board 418 is configured to calculate the pressure based on a signal transmitted from the liquid crystal panel via the flexible substrate 417. Accordingly, size reduction of the driver 416 is achievable in comparison with a configuration which incorporates the calculation unit 421 in a driver mounted on a liquid crystal panel or a flexible substrate.

### Other Embodiments

The present invention is not limited to the embodiments described above and depicted in the drawings. For example, following embodiments are also included in the technical scope of the present invention.

(1) According to the respective embodiments described above, a difference of a signal associated with electrostatic capacitance is multiplied by a correction coefficient. However, when only a small difference or no difference of a flexible volume of the liquid crystal panel is produced by a pressing action in the plane of the display surface, the difference may be directly converted into a pressure value without multiplication by a correction coefficient.

(2) The specific shapes of the housing and the bottom portion in the respective embodiments described above may be appropriately modified into other shapes.

(3) While the arrangement of the position detection electrodes and the wires is schematically depicted in the respective embodiments described above, the specific planar positions, the planar shapes, the numbers of the position detection electrodes and the wires to be provided and the like may be appropriately changed from those depicted in the figures. In addition, the order of lamination of the wires (lamination positions) for the respective lamination films on the array substrate may be appropriately varied.

(4) According to the respective embodiments described above, the cover glass is provided. However, a protection film made of synthetic resin may be provided instead of the cover glass. Furthermore, the cover glass and the protection film may be removed.

(5) According to the respective embodiments described above, a position is input by using the finger of the user. However, a position may be input by using a position input body other than a finger, such as a touch pen.

(6) According to the respective embodiments described above, the position detection electrode also functions as the common electrode. However, the position detection electrode may be provided separately from the common electrode.

(7) While the configurations presented in the respective embodiments described above form the touch panel pattern (e.g., position detection electrodes and wires) within the liquid crystal panel (in-cell type), the present invention is applicable to a configuration which forms a touch panel pattern in a touch panel laminated on the liquid crystal panel (out-cell type).

(8) According to the respective embodiments described above, the liquid crystal panel has a rectangular planar shape. However, the present invention is applicable to a liquid crystal panel having a planar shape of a square, circle, ellipse, or other shapes.

(9) According to the respective embodiments described above, the driver is mounted on the array substrate of the liquid crystal panel by COG mounting. However, the driver may be mounted on the flexible substrate by chip on film (COF) mounting.

(10) According to the respective embodiments described above by way of example, the semiconductor films constituting channel portions of TFTs are made of oxide semiconductor material. However, the semiconductor films may be made of polysilicon (continuous grain silicon (CG silicon) which is a type of polycrystallized silicon (polycrystalline silicon) or amorphous silicon.

(11) According to the respective embodiments described above by way of example, the operation mode of the liquid crystal panel is the FFS mode. However, the present invention is applicable to a liquid crystal panel having other operation modes such as an in-plane switching (IPS) mode and a vertical alignment (VA) mode.

(12) According to the respective embodiments described above by way of example, the color filters of the liquid crystal panel has a three-color configuration of red, green, and blue. However, the present invention is applicable to a color filter having a four-color configuration which adds a yellow colored portion to the respective colored portions of red, green, and blue.

(13) According to the respective embodiments described above by way of example, the liquid crystal panel is classified into a group of a small size or a medium and small size. However, the present invention is applicable to a liquid crystal panel having a screen size ranging from 20 inches to 100 inches, for example, and classified into a group of a middle size or large size (extra-large size). In this case, the liquid crystal panel is applicable to an electronic device such as a television receiving device, an electronic signage (digital signage), and an electronic blackboard.

(14) According to the respective embodiments described above by way of example, the configuration of the liquid crystal panel includes the liquid crystal layer sandwiched between a pair of the substrates. However, the present invention is applicable to a display panel which includes functional organic molecules other than liquid crystal material sandwiched between the pair of substrates.

(15) According to the respective embodiments described above, TFTs are adopted as switching elements of the liquid crystal panel. However, the present invention is applicable to a liquid crystal panel which adopts switching elements other than TFTs (e.g., thin film diodes (TFDs)), or applicable to a liquid crystal panel for black-white display as well as a liquid crystal panel for color display.

### EXPLANATION OF SYMBOLS

10: Liquid crystal display device (Display device with position input function)
11, 211: Liquid crystal panel (Display panel)
11a: CF substrate (Substrate)
11b: Array substrate (Substrate)
11g: Pixel electrode
11h: Common electrode
11hS: Divisional common electrode
11DS, 211DS: Display surface
15, 215: Housing
15a, 215a: Bottom portion
16, 416: Driver
17, 417: Flexible substrate (Connection part)
18, 418: Control board (Control circuit board)
19, 419: Position detection electrode
20, 420: Wire
21, 421: Calculation unit
22, 422: Memory
F: Finger (Position input body)

1. A display device with position input function, the display device comprising:
a display panel;
a housing accommodating the display panel, made of conductive material, and disposed to cover at least a surface of the display panel on an opposite side from a display surface of the display panel;
a position detection electrode disposed on the display panel such that the position detection electrode and the housing have electrostatic capacitance therebetween and the position detection electrode and a position input body that inputs a position in a plane of the display surface have electrostatic capacitance therebetween to detect an input position of the position input body; and
a calculation unit configured to calculate a pressure in a normal direction to the display surface based on a difference in signal regarding the electrostatic capacitance detected when a position change regarding the input position of the position input body detected by the position detection electrode is within a specified range.

2. The display device with position input function according to claim 1, wherein the calculation unit is configured to calculate the pressure by multiplying the difference by a correction coefficient corresponding to an input position on the display surface.

3. The display device with position input function according to claim 1, further comprising a memory that stores, as a reference value, a signal associated with electrostatic capacitance acquired when a variation associated with an input position detected by the position detection electrode exceeds a threshold, wherein
the calculation unit calculates the pressure based on a difference between a signal associated with electrostatic capacitance acquired when the variation does not exceed the threshold, and the reference value stored in the memory.

4. The display device with position input function according to claim 3, wherein the memory stores, as the reference value, a peak value in the signal associated with the electrostatic capacitance acquired when the variation exceeds the threshold.

5. The display device with position input function according to claim 1, wherein:
the housing includes a bottom portion that covers the surface of the display panel opposite to the display surface; and
the bottom has a shape curved such that a distance between the bottom portion and the display panel gradually decreases from a central region of the display surface toward an end region of the display surface.

6. The display device with position input function according to claim 1, wherein:
a driver configured to drive the position detection electrode is mounted on the display panel; and
the calculation unit is included in the driver.

7. The display device with position input function according to claim 1, the display device further comprising:
a connection part one end of which is connected to the display panel; and
a control circuit board connected to the other end of the connection part, wherein
the calculation unit is included in the control circuit board.

8. The display device with position input function according to claim 1, wherein the calculation unit does not calculate the pressure when the difference does not exceed a threshold, but calculates the pressure when the difference exceeds the threshold.

9. The display device with position input function according to claim 1, wherein the position detection electrode is formed within the display panel.

10. The display device with position input function according to claim 9, wherein:
the display panel includes at least a pixel electrode to which voltage is applied with gradation corresponding to an image displayed on the display surface, and a common electrode to which common potential is applied; and
the common electrode includes a plurality of divisional common electrodes disposed in a matrix in the plane of the display surface, and constituting the position detection electrode.

11. The display device with position input function according to claim 10, wherein the display panel includes at least a plurality of wires each of which is individually connected to the corresponding one of the plurality of divisional common electrodes.

12. The display device with position input function according to claim 10, wherein:
the display panel includes at least a pair of substrates overlapped with the display panel on the housing side and on the opposite side, respectively; and
the position detection electrode is provided on the substrate disposed on the housing side as one of the pair of substrates.
